(19) United States
(12) Patent Application Publication
(10) Pub. No.: US 2019/0059048 A1
(43) Pub. Date: Feb. 21, 2019

(54) SYSTEM FOR SELECTING WIRELESS LOCAL AREA NETWORK (WLAN) IN LTE-WLAN AGGREGATION (LWA)

(71) Applicant: Telekom Malaysia Berhad, Wilayah Persekutuan Kuala Lumpur (MY)

(72) Inventors: Chun Yeow Yeoh, Selangor (MY); Mohd Azmi Bin Ismail, Selangor (MY); Ahmad Kamsani Bin Samingan, Johor (MY)

(21) Appl. No.: 15/897,751

(22) Filed: Feb. 15, 2018

(30) Foreign Application Priority Data
Aug. 17, 2017 (MY) PI 2017703030

(51) Int. Cl. H04W 48/18; H04W 48/20; H04W 76/10; H04W 24/10

(52) U.S. Cl. CPC H04W 48/18; H04W 48/20; H04W 84/12; H04W 24/10; H04W 76/10

(57) ABSTRACT

The present invention relates to a system for selecting a Wireless Local Area Network (WLAN) in LTE-WLAN Aggregation (LWA). The system comprises a user equipment (UE) (101), a logical interface (Xw) (102), a wireless termination (WT) node (103) that terminates the Xw (102) on the WLAN, an eNodeB (eNB) (104) connected to the WT by the Xw (102), and a WLAN access controller (WLAN AC) (105) comprising WLAN access points (APs) (106) connected to the WT. The system further comprises a WLAN information acquisition module (201) for preparing a WLAN measurement report (201 b), a WLAN network selection control module (202) for verifying the BSSID of WLAN APs in the said list, and a WLAN network selection and association module (203) for attempting to make a connection by rendering BSSID (203a) to perform connection.

### CROSS-REFERENCE TO RELATED APPLICATIONS

This application claims priority to Malaysian Invention Patent Application No. PI 2017703030, filed on Aug. 17, 2017.

### FIELD OF THE INVENTION

The present invention relates generally to arrangement for network selection. More particularly, the present invention relates to an improved system for selecting Wireless Local Area Network (WLAN) in LTE-WLAN Aggregation (LWA).

### BACKGROUND OF THE INVENTION

Due to the growing mobile traffic demand, internetworking between the Long Term Evolution (LTE) network and the unlicensed spectrum, such as WLAN, to provide additional bandwidth to the operators is getting more attentions these days. LTE WLAN aggregation provides data aggregation at the radio access network where an eNB schedules packets to be served on both LTE and WLAN radio link.

3rd Generation Partnership Project (3GPP) has defined network control LWA in Release-13 for both collocated and non-collocated scenarios. A logical interface (Xw) is introduced to connect the Evolved Node B (eNB) and the Wireless Termination (WT). The WT can either be assembled together at WLAN Access Controller/Access Points (WLAN AC/APs) (collocated LWA) or as a separate network entity (non-collocated). The Xw interface on the other hand, can either be Layer 3 (L3) based i.e. Internet Protocol (IP) or Layer 2 (L2) based i.e. Ethernet. In Release-14, further enhancements on LWA are introduced to support uplink aggregation, additional feedbacks and automatic neighbor relationship (ANR). For rapid LWA deployment and ability to support the legacy WLAN AC/APs, WT can be located and installed at the data center. Less significant improvement and enhancement are required in deploying LWA to existing WLAN AC/APs compared to embedding the WT inside the WLAN AC/APs. Also this provides flexibility for further enhancement on the WT node.

In LWA, eNB is responsible for LWA activation, de-activation and the decision as to which bearers are offloaded to the WLAN. Once LWA is activated, the eNB configures the UE with a list of WLAN identifiers referred to as the WLAN mobility set. A WLAN mobility set is a set of one or more WLAN APs identified by one or more WLAN Service Set Identification (SSIDs), Basic Service Set Identification (BSSID) and Homogenous Extended Service Set Identification (HESSID). A UE is connected to at most one mobility set at a time. When the UE is configured with a WLAN mobility set, it will attempt to connect to a WLAN whose identifiers match the ones of the configured mobility set. UE mobility to WLAN APs not belonging to the UE mobility set is controlled by the eNB. But for WLAN APs belonging to the same mobility set, the UE may perform mobility between them without informing the eNB.

WLAN network selection procedure for LWA activation can be summarized in three important steps: WLAN information acquisition, WLAN network selection control and WLAN network selection and association. During the WLAN information acquisition, the UE acquires information from its surrounding WLAN APs and reports them to the eNB. Then, during the WLAN network selection control, the eNB generates the controlled command with a set of assistance information after processing the WLAN information and then down-selecting the desired WLAN networks for UE to associate to. Subsequently, the UE selects and associates to the WLAN network based on the set of assistance information from the eNB.

To reduce the operation and management (O&M) effort, SSID or human-readable strings (network name) is usually chosen as targeted WLAN identifiers. If the SSID is chosen as targeted WLAN identifiers, the UE may performs the WLAN measurement and reports per SSID. As defined by 3GPP TS 36.300, if a mobility set is configured using SSID as targeted WLAN identifiers, the UE can move from one WLAN AP to another without informing the eNB. Then, the eNB has no control over which WLAN AP that the UE associates to. If the eNB cannot exercise certain level of control to optimize the WLAN network selection performed by the UE, the following problems may occur:
i. Suboptimal performance if UE throughput requirement is not satisfied due to unavailability of the measurement reporting per BSSID from the UE.
ii. On-going data connection or LWA bearer will be broken if the selected WLAN AP by the UE does not support LWA.
iii. Latency delays if WT has no prior information about the WLAN AP before UE switches to a new WLAN AP within its mobility set.

A need therefore exists for a system intended to improve and to enhance the WLAN network selection for LWA activation whenever operators opt for SSID as targeted WLAN identifier. Accordingly, it is an object of the present invention to overcome or at least ameliorate one or more of the disadvantages of the prior art.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

Accordingly, the present invention provides to an improve system for selecting a Wireless Local Area Network (WLAN) in LTE-WLAN Aggregation (LWA).

The system of the present invention can be characterized by user equipment (UE), a logical interface (Xw), a wireless termination (WT) node that terminates the Xw on the WLAN, an eNodeB (eNB) connected to the WT by the Xw and a WLAN access controller (WLAN AC) comprising WLAN access points, (APs) connected to the WT. The system preferably comprises a WLAN information acquisition module for generating a WLAN measurement report comprising a list of WLAN APs accompanied with respective Basic Service Set Identifier (BSSID), constructed based on a received LWA assistance configuration, wherein the received LWA assistance configuration comprises a WLAN identifier that is adopted as a Service Set Identifier (SSID), wherein the list of WLAN APs comprises WLAN APs having the same WLAN identifier with respect to each other, and are named as <SSID:BSSID>, wherein the WLAN APs in the said list are ranked based on a received signal strength indicator (RSSI) and are prioritized in an order of decreasing RSSI thereof; a WLAN network selection control module for verifying the BSSID of WLAN APs in the said list by creating a Layer 3 tunneling and by requesting a list of AP Media Access Control (MAC) addresses from the WLAN AC, wherein the list of AP MAC addresses are compared against the BSSID of WLAN APs in the WLAN measurement report, wherein replacing the WLAN identifier in the received LWA assistance configuration with the BSSID correspondingly; and a WLAN network selection and association module for attempting to make a connection by rendering BSSID to perform connection.

Preferably, the name of <SSID:BSSID>, the SSID is a targeted WLAN identifier and BSSID is a WLAN APs MAC addresses.

Preferably, the WLAN network selection control module is configured to validate that the BSSID of the WLAN APs in the list matches with the MAC addresses retrieved from the WLAN AC.

In accordance with another aspect of the present invention, a method for selecting a WLAN in LWA is provided.

The method can be characterized by the steps of generating a WLAN measurement report comprising a list of WLAN APs accompanied with respective BSSID, constructed based on a received LWA assistance configuration, wherein the received LWA assistance configuration comprises a WLAN identifier that is adopted as a SSID, wherein the list of WLAN APs comprises WLAN APs having the same WLAN identifier with respect to each other, and are named as <SSID:BSSID>, wherein the step of generating a WLAN measurement report includes ranking the WLAN APs in the said list based on RSSI and are prioritized in an order of decreasing RSSI thereof; verifying the BSSID of WLAN APs in the said list by creating a Layer 3 tunneling and by requesting a list of AP MAC addresses from the WLAN AC, wherein replacing the WLAN identifier the received LWA assistance configuration with the BSSID correspondingly; and attempting to make a connection by rendering BSSID to perform connection.

It is therefore an advantage of the present invention that improves and enhances the WLAN network selection for LWA that provides better control and utilization of resource on both links (LTE and WLAN). In this way, increase the aggregate throughput for all users and improve the total system capacity by better managing the radio resources among users.

It is therefore another advantage of the present invention that solves the problem of WT to obtain the AP MAC address from legacy WLAN AP/AC.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

A more complete appreciation of the invention and many of the attendant advantages thereof will be readily as the same becomes better understood by reference to the following detailed description when considered in connection with the accompanying drawings, wherein:

FIG. 1 is the LTE-WLAN Aggregation (LWA) network architecture according to one embodiment of the present invention;

FIG. 2 shows the block diagram of Wireless Local Area Network (WLAN) selection for LWA activation according to according to one embodiment of the present invention;

FIG. 3 shows the flow chart of a WLAN information acquisition module according to one embodiment of the present invention;

FIG. 4 shows the flow chart of a WLAN network selection control module according to according to one embodiment of the present invention; and

FIG. 5 shows the flow chart of a WLAN network selection and association according to according to one embodiment of the present invention.

It is noted that the drawings may not be to scale. The drawings are intended to depict only typical aspects of the invention, and therefore should not be considered as limiting the scope of the invention. In the drawings, like numberings represent like elements between the drawings.

### DETAILED DESCRIPTION OF THE INVENTION

It is an object of the present invention to provide an improved system for selecting Wireless Local Area Network (WLAN) in LTE-WLAN Aggregation (LWA). The present invention advantageously increases the aggregate throughput for all users and improves the total system capacity by better managing the radio resources among users.

Accordingly, the present invention provides a method intended to improve and to enhance the WLAN network selection for the LWA activation enable operators to use access points names, the Service Set Identifier (SSID) as targeted WLAN identifiers to reduce the Operation and Maintenance (O&M) efforts. The present invention, with the implementation advantageously can provide the eNodeB (eNB) 104 to exercise certain level of control to optimize the WLAN network selection performed by the user equipment (UE) 101 even if the mobility set is based on the SSID. The system of the present invention allows the UE 101 to report WLAN measurement per Basic Service Set Identifier (BSSID) for all the WLAN APs 106 107 108 within the proximity of the UE 101 that broadcast the same SSID. Last but not least, the present invention helps operators to deploy the LWA utilizing the legacy WLAN infrastructure in directly solving the problem of the WT 103 to obtain the AP MAC addresses from the legacy WLAN.

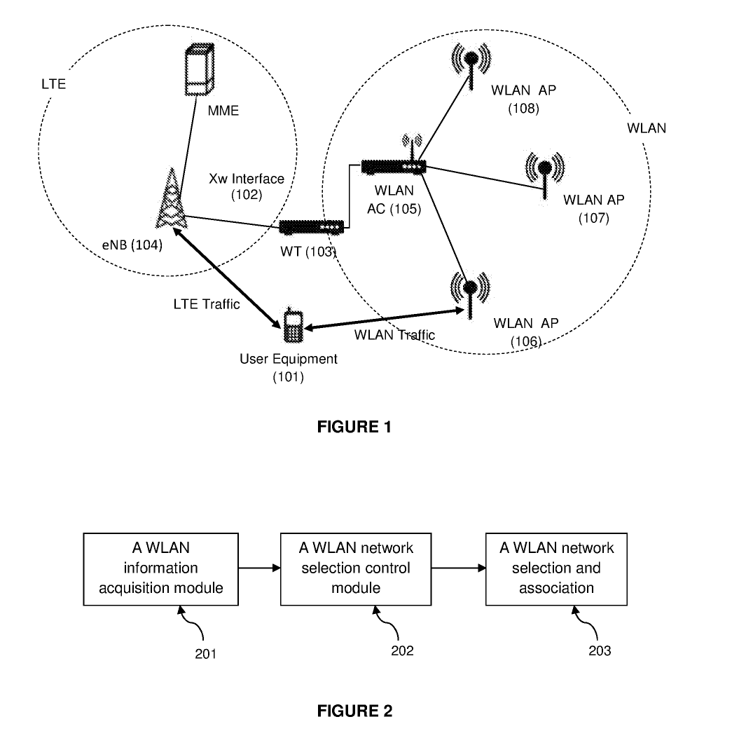

FIG. 1 illustrates a LWA network architecture according to one embodiment of the present invention. The system preferably comprises a UE 100 with dual connectivity, a logical interface (Xw) 102, a wireless termination node (WT) 103 that terminates the Xw 102 on the WLAN, a main base station referred as eNodeB (eNB) 104 connected to the WT 103 by the Xw 102 and a WLAN access controller (WLAN AC) 105 comprising WLAN access points (APs) 106 connected to the WT 103.

In one exemplary configuration, when the UE 101 is configured with dual connectivity, the UE 101 is served by the eNB 104 with an uplink and downlink. At the same time the UE 101 is also served by the WLAN AP 106 with an uplink and downlink. The UE 101 is configured to be LWA-enabled and can perform data aggregation between the eNB 104 and the WLAN AP 106 which in the range of the UE 101. The UE 101 subsequently moves within the coverage area of the eNB 104 while moving into the coverage area of the WLAN. Upon entering WLAN's coverage area, the UE 101 can select a WLAN AP 106 to aggregate its data traffic if needed. In such situation LTE-WLAN aggregation can be configured for the UE 101. The coordination between LTE and WLAN mobility set can be performed through a Xn interface, for example, a Xw 102 or a X2 interface. The Xn interface also known as backhaul connections provide communication and coordination. The eNB 104 triggers the WT 103 to perform measurement reporting update with the following notable Xw 102 parameters:
eNB 104→WT 103: request WT 103 to provide WLAN measurement reporting per BSSID.
WT 103 to eNB 104: availability of BSSID on WLAN measurement reporting.

According to preferred embodiment of the present invention, the system for WLAN network selection comprises a WLAN information acquisition module 201, a WLAN network selection control module 202, and a WLAN network selection and association 203—the arrangement of general block diagram of the present invention which is shown by FIG. 2.

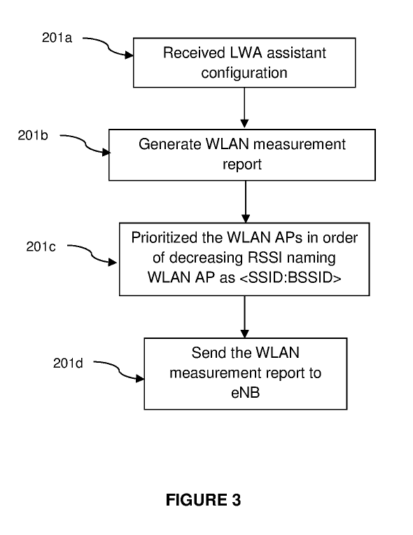

The WLAN information acquisition module 201 of the present invention involves several steps as depicted in FIG. 3. The UE 101 obtains a LWA assistant configuration at step 201a. The eNB 104 may send the LWA assistance information to the UE 101. The LWA assistance information may be specific to a particular WLAN or apply to all WLAN providing LWA access. The LWA assistance information may be broadcast as system information and/or be transferred over dedicated Radio Resource Control (RRC) Protocol signaling. The LWA assistance may include of one or more of the following information elements: 1) The WLAN association status when connected, 2) Identity of the associated WLAN AP 106 (SSID, BSSID, and/or HESSID), 3) the UE's 101 IEEE Media Access Control Address (MAC) address, 4) The UE's 101 Internet Protocol (IP) address (if connected and the UE 101 receives an IP address for the WLAN network interface). The IP address could refer to an Internet Protocol version 4 (IPv4) address, Internet Protocol version 6 (IPv6) address, or include both an IPv4 and an IPv6 address, and 5) Summary WLAN statistics. These statistics could include measured data rates in uplink and downlink direction, time of association, the WLAN channel utilization, the WLAN backhaul rates. These summary statistics can also be reported separately or primary and secondary channels (e.g., in the case of 802.11ac) or be reported in a combined fashion.

The eNB 104 may specify a list of WLAN APs 106 107 108 and/or WLAN frequency channels for the UE 101 to scan, or require the UE 101 to scan all available WLAN APs 106 107 108 and/or WLAN frequency channels. The eNB 104 can also control how the UE 101 reports the result of its measurements to the eNB 104. The WLAN identifier assigned by the eNB 104 is used to indicate to the UE 101 which WLAN to consider for the measurement control procedures. Thus, if the target identification is per SSID, the measurement reporting is per SSID.

The UE 101 generates WLAN measurement report by listing out WLAN APs 106 107 108 which broadcasting the same WLAN identifier in LWA assistant configuration as in step 201b. Next, in step 201c the best WLAN AP 106 are included first by listing the WLAN APs 106 107 108 in order of decreasing Received Signal Strength Indicator (RSSI) and named as <SSID:BSSID>. SSID is the targeted WLAN identifier provided by the eNB 104 using RRC signaling. BSSID on the other hand, is the WLAN AP's 106 107 108 MAC address that is able to capture by the UE 101 while performing WLAN measurement. WLAN measurement reporting may consists of the following WLAN metrics: WLAN identifiers, carrier info, Band, RSSI, Available Admission Capacity, Backhaul Download DL Bandwidth, Backhaul Upload UL Bandwidth, Channel Utilization, Station Count WLAN, and Connected WLAN. At step 201d, the UE 101 sends WLAN measurement report to the eNB 104.

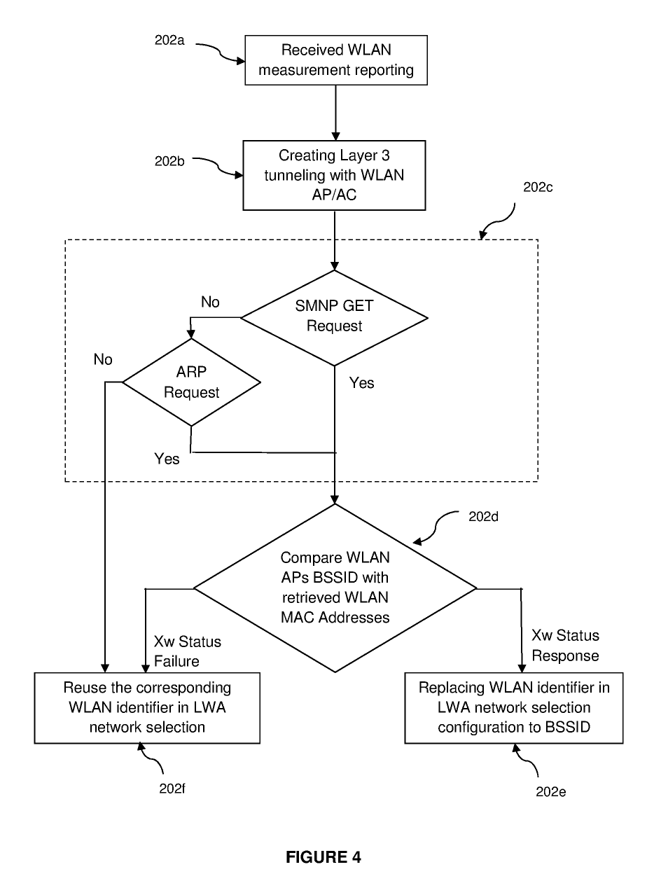

FIG. 4 is an exemplary flow chart of a WLAN network selection control module according to another preferred embodiment of the present invention. Upon receiving WLAN measurement reporting from the UE 101 in the step 202a, the eNB 104 is then utilizing the Xw 102 signaling defined in 3GPP TS 36.463, i.e. a WT 103 Status Request, to further verify whether the WT 103 has listed this WLAN AP 106 as LWA capable or not. For WT 103 that is deployed as separate entity in LWA deployment (non-collocated) may setup a layer 3 tunneling towards WLAN AC 105 to have Ethernet frames flow towards the WLAN AC i.e.: a Layer 2 Tunneling Protocol (L2TP) or Ethernet over IP (EoIP) as in step 202b.

The WT 103 will then requesting for WLAN MAC addresses by sending Simple Network Management Protocol (SNMP) GET request, as in step 202c. SNMP exposes management data in the form of variables on the managed systems organized in a management information base (MIB) which describe the system status and configuration. In the case that the MIB is not available in the WLAN AC, the WT 103 can utilize the ARP Request in step 202d to resolve whether the MAC address is reachable. Systems keep an ARP look-up table where they store information about what IP addresses are associated with what MAC addresses. When trying to send a packet to an IP address, the system will first consult this table to see if it already knows the MAC address. At step 202e, the WT 103 compares the WLAN APs 106 107 108 BSSID with retrieved WLAN MAC Addresses for validity. After the MAC address is successfully verified, the WT 103 can then reply to the eNB 104 utilizing the Xw 102 signaling i.e. WT 103 status Response, together with triggering WLAN identifier in received the LWA network selection configuration to BSSID as in step 202f. However, in the case of step 202g the AP MAC address is failed to be verified, the WT 103 can then again reply to the eNB 104 utilizing the Xw 102 signaling, i.e. WT 103 Status Failure and reuse the corresponding WLAN identifier in LWA network selection.

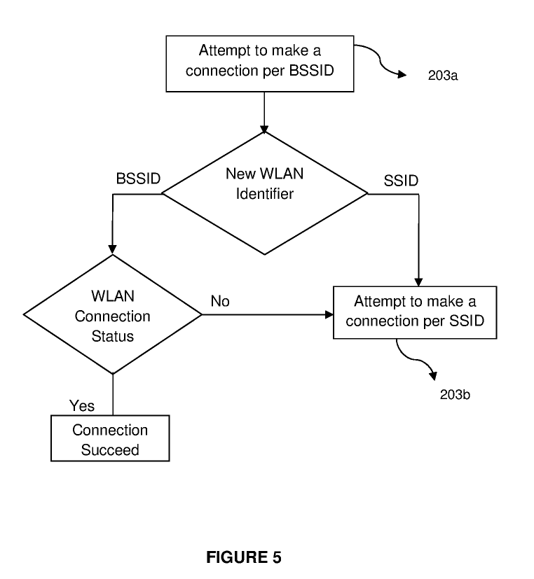

FIG. 5 shows the flow chart of a WLAN network selection and association according to another exemplary embodiment of the present invention. At step 203a, the UE 101 will attempt to make a connection as per BSSID. However, at step 203b if the connection fails, the UE 101 will attempt to make another connection as per SSID.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

While this invention has been particularly shown and described with reference to the exemplary embodiments thereof, it will be understood by those skilled in the art that various changes in form and details may be made therein without departing from the scope of the invention as defined by the appended claims.

1. A system for selecting a Wireless Local Area Network, WLAN in LTE-WLAN Aggregation, LWA, comprising:
a user equipment, UE (101);
a logical interface, Xw (102);
a wireless termination, WT node (103) that terminates the Xw (102) on the WLAN;
an eNodeB, eNB (104) connected to the WT by the Xw (102); and
a WLAN access controller, WLAN AC (105) comprising WLAN access points, APs (106) connected to the WT;
characterized in that, the system further comprising:
a WLAN information acquisition module (201) for generating a WLAN measurement report (201b) comprising a list of WLAN APs accompanied with respective Basic Service Set Identifier, BSSID, constructed based on a received LWA assistance configuration (201a),
wherein the received LWA assistance configuration (201a) comprises a WLAN identifier that is adopted as a Service Set Identifier, SSID,
wherein the list of WLAN APs comprises WLAN APs having the same WLAN identifier with respect to each other, and are named as <SSID:BSSID>,
wherein the WLAN APs in the said list are ranked based on a received signal strength indicator, RSSI and are prioritized in an order of decreasing RSSI (201c) thereof;
a WLAN network selection control module (202) for verifying the BSSID of WLAN APs in the said list by creating a Layer 3 tunneling (202b) and by requesting a list of AP Media Access Control, MAC addresses (202c) from the WLAN AC, wherein the list of AP MAC addresses are compared against the BSSID (202d) of WLAN APs in the WLAN measurement report, wherein replacing the WLAN identifier (202e) in the received LWA assistance configuration (201a) with the BSSID correspondingly; and
a WLAN network selection and association module (203) for attempting to make a connection by rendering BSSID (203a) to perform connection.

2. The system according to claim 1, wherein the name of <SSID:BSSID>, the SSID is a targeted WLAN identifier and BSSID is a WLAN APs MAC addresses.

3. The system according to claim 1, wherein the WLAN network selection control module is configured to validate that the BSSID of the WLAN APs in the list matches with the MAC addresses retrieved from the WLAN AC.

4. A method for selecting a Wireless Local Area Network, WLAN in LTE-WLAN Aggregation, LWA, characterized in that, the method comprising the steps of:
generating a WLAN measurement report (201b) comprising a list of WLAN APs accompanied with respective Basic Service Set Identifier, BSSID, constructed based on a received LWA assistance configuration (201a),
wherein the received LWA assistance configuration (201a) comprises a WLAN identifier that is adopted as a Service Set Identifier, SSID,
wherein the list of WLAN APs comprises WLAN APs having the same WLAN identifier with respect to each other, and are named as <SSID:BSSID>,
wherein the step of generating a WLAN measurement report (201b) includes ranking the WLAN APs in the said list based on a received signal strength indicator, RSSI and are prioritized in an order of decreasing RSSI (201c) thereof;
verifying the BSSID of WLAN APs in the said list by creating a Layer 3 tunneling (202b) and by requesting a list of AP Media Access Control, MAC addresses (202c) from the WLAN AC, wherein the list of AP MAC addresses are compared against the BSSID (202d) of WLAN APs in the WLAN measurement report; wherein replacing the WLAN identifier (202e) in the received LWA assistance configuration (201a) with the BSSID correspondingly; and
attempting to make a connection by rendering BSSID (203a) to perform connection.
